(19) United States
(12) Patent Application Publication
(10) Pub. No.: US 2024/0422464 A1
(43) Pub. Date: Dec. 19, 2024

(54) ELECTRICAL EQUIPMENT INTEGRATING A SPEAKER

(71) Applicant: SAGEMCOM BROADBAND SAS, Bois-Colombes (FR)

(72) Inventor: Hugo CHUSSEAU, Bois-Colombes (FR)

(21) Appl. No.: 18/735,453

(22) Filed: Jun. 6, 2024

(30) Foreign Application Priority Data
Jun. 13, 2023 (FR) FR2305999

(51) Int. Cl. H04R 1/02

(52) U.S. Cl. CPC H04R 1/028; H04R 1/025; H04R 2201/02

(57) ABSTRACT

Electrical equipment includes a casing defining a chamber. A motherboard and a speaker connected to the motherboard are disposed, and a membrane of the speaker opens into at least one opening provided in an upper panel of the casing. The motherboard extends into a first transverse plane of the speaker, and this first plane is substantially parallel to the upper panel. The electrical equipment is a set-top box.

The invention relates to the field of electrical equipment integrating a speaker.

### BACKGROUND OF THE INVENTION

A set-top box or STB is a piece of electrical equipment intended to be connected to a television and used for various functions and different services, like digital television.

A set-top box generally comprises a chassis surmounted with a cap, the chassis and the cap delimiting a chamber, wherein a motherboard is disposed, extending substantially horizontally.

Set-top boxes equipped with a microphone and a speaker connected to the motherboard to ensure the voice assistant function are known. The speaker is generally arranged under the motherboard, such that the height of a set-top box equipped with a voice assistant is greater than that of a set-top box with no voice assistant.

The speaker is arranged facing an opening provided on the chassis or a flank of the cap, such that the speaker is respectively oriented downwards or sidewards. When the speaker is oriented downwards, it is necessary to increase the height of the feet on which the set-top box rests and/or to provide an outflow on the lower face of the chassis, so as to guarantee a sufficient propagation of the sound waves generated by the speaker. Subsequently, this downwards orientation also significantly impacts on the height, but also on the general overall volume of the set-top box.

### AIM OF THE INVENTION

The invention aims to propose an arrangement of a speaker in a piece of electrical equipment making it possible to limit the dimensions of the electrical equipment, and in particular, its height.

### SUMMARY OF THE INVENTION

In view of achieving this aim, a casing is proposed, defining a chamber, wherein a motherboard and a speaker connected to the motherboard are disposed.

A membrane of the speaker opens into at least one opening provided in an upper panel of the casing, and the motherboard extends into a first transverse plane of the speaker, this first plane being substantially parallel to the upper panel.

According to the invention, the speaker comprises a square-shaped base extending into a second plane substantially parallel to the upper panel, none of the edges of the base extending parallel to an edge of the upper panel seen from the second plane.

The speaker is thus not arranged below or above the motherboard, but at the same level as that of said motherboard, which makes it possible to limit the height of the casing.

What is more, by opening onto the upper panel, the speaker is called upwards oriented. Such an integration of the speaker in the casing does not require extending the chassis of the casing of the support on which it rests or outflowing a lower face of said chassis of a sufficient height to enable a propagation of the sound waves generated by the speaker, which also makes it possible to limit the height of the casing, but also to limit the general overall volume of the electrical equipment.

According to a feature of the invention, the upper panel is rectangular-shaped, the opening being provided in a corner of the upper panel.

According to another feature of the invention, the casing comprises a chassis comprising ridges comprising a first series of ridges and a second series of ridges which extend vertically from a bottom of the chassis and which are respectively disposed in the central part of the bottom of the chassis and at the periphery of the central part, the first series of ridges being arranged according to a honeycomb structure comprising hexagon-shaped pits.

The invention also relates to a set-top box comprising such a piece of electrical equipment.

### BRIEF DESCRIPTION OF THE DRAWINGS

The invention will be best understood in the light of the description below, which is purely illustrative and non-limiting, and must be read regarding the accompanying drawings, among which:

FIG. 1 is a perspective, top view from the front, of a piece of electrical equipment according to a particular embodiment of the invention, in a nominal operating position;

FIG. 2 is an exploded view of the electrical equipment illustrated in FIG. 1;

FIG. 3 is a bottom view of the electrical equipment illustrated in FIG. 1, with no chassis;

FIG. 4 is a cross-sectional view of the electrical equipment illustrated in FIG. 1, in a plane comprising a central axis of the speaker;

FIG. 5 is a perspective, top view from a side, of the chassis of the electrical equipment illustrated in FIG. 1; and

FIG. 6 is a perspective, top view from a side, of the chassis and of the speaker of the electrical equipment illustrated in FIG. 1.

### DETAILED DESCRIPTION OF THE INVENTION

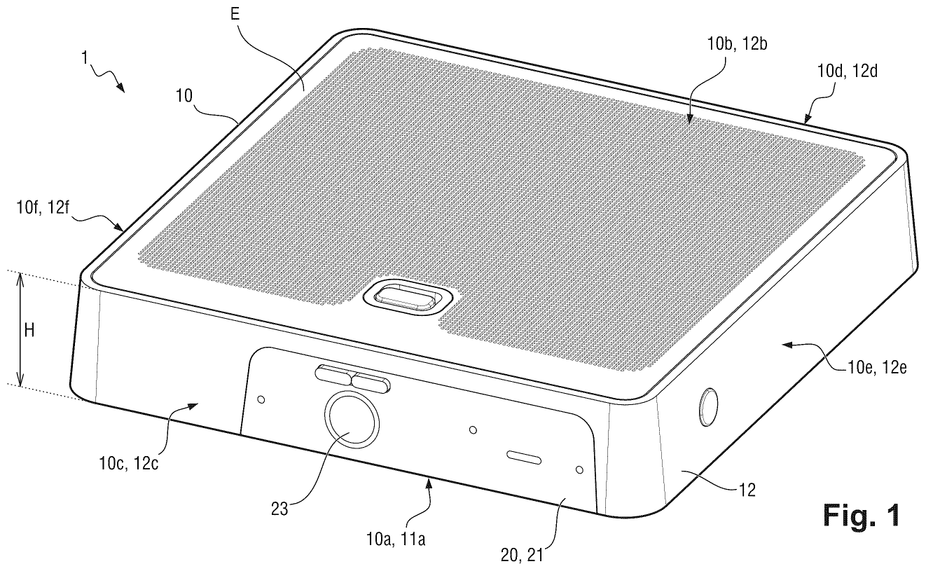

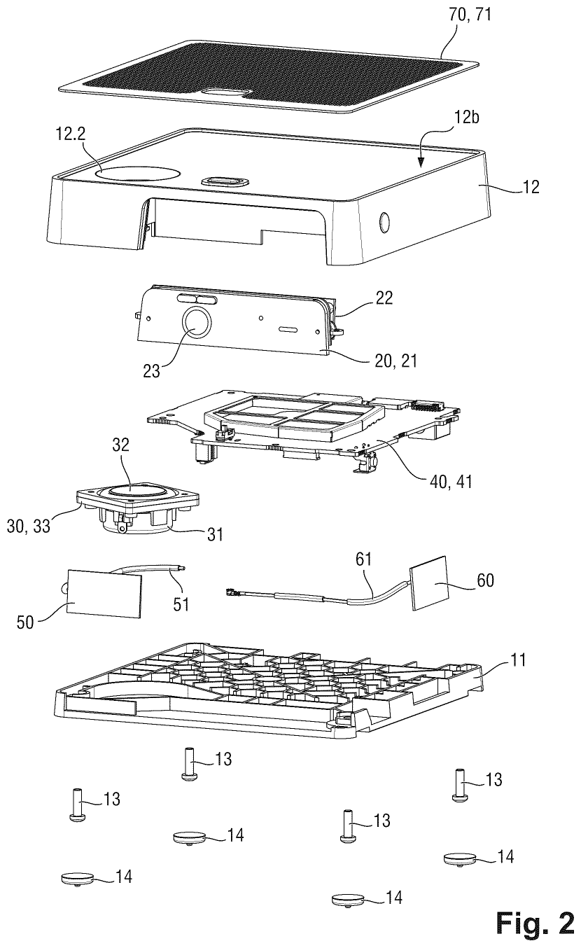

In reference to FIGS. 1 and 2, a set-top box generally referenced as 1, according to a particular embodiment of the invention, comprises a casing 10 defining a chamber E, wherein an electrical module 20, a speaker 30, a main electronic board or motherboard 40, a first antenna 50 and a second antenna 60 are disposed. The casing 10 is, in this case, made of a plastic material and has a height H substantially equal to 24 millimetres.

The casing 10 is mainly parallelepiped-shaped and comprises a chassis 11 surmounted with a cap 12.

The chassis 11 comprises a lower panel 11a, mainly rectangular-shaped, comprising an upper face and a lower face forming a lower face 10a of the casing 10.

The cap 12 comprises an upper panel 12b and a skirt having an upper edge connected to the perimeter of the upper panel 12b.

The upper panel 12b, mainly rectangular-shaped, comprises an upper face forming an upper face 10b of the casing 10, and a lower face forming a bottom of the cap 12.

The skirt has its four rounded corners and comprises:
a front panel 12c connected to a front edge of the upper panel 12b to form a front face 10c of the casing 10;
a rear panel 12d opposite the front panel 12c and connected to a rear edge of the upper panel 12b to form a rear face 10d of the casing 10;
a right side panel 12e connected to a side edge of the upper panel 12b, to a side edge of the front panel 12c and to a side edge of the rear panel 12d to form a side face 10e of the casing 10; and
a left side panel 12f, opposite the right side panel 12e, connected to a side edge of the upper panel 12b, to a side edge of the front panel 10a and to a side edge of the rear panel 12d to form a left side face 10f of the casing 10.

The set-top box 1, when it is in its nominal operating position, is installed such that the chassis 11 of the casing 10 rests via four feet 13 on a substantially horizontal support (for example, the furniture on which the television is also placed, to which the set-top box 1 is connected), and that the front face 10c of the casing 10 is located facing the user. The feet 13 are received in fixing studs 11.6 provided in the four corners of the chassis 11 and are, in this case, provided with runners 14 forming uncoupling tips so as to limit the transmission of vibrations generated by the speaker 30 to the support on which the set-top box 1 rests.

In this case, all the positional terms, such as “front”, “rear”, “upper”, “lower”, “left”, “right”, “horizontal” and “vertical” are interpreted by considering that the set-top box 1 is in its nominal operating position and is seen from the front (as if it was seen by the user).

In reference to FIG. 2, the front panel 12c of the cap 12 comprises, on the right side, an indentation 12.1 (or cutout) arranged to receive the electrical module 20. The indentation 12.1, mainly trapezoidal-shaped, extends from a lower edge of said front panel 12c and comprises side edges and an upper edge extending to the vicinity of the front edge of the upper panel 12b, substantially parallel to it.

The electrical module 20 comprises a support 21 and an electronic board 22 fixed to the support 21.

The support 21 has a general shape which is complementary to that of the indentation 12.1 and is received in the indentation 12.1, such that said support 21 is in contact with the upper edge and the side edges of said indentation 12.1. The support 21 comprises a front face 21c extending into the extension of the front face 10c of the casing 10, and a rear face, opposite the front face 21c, from which screwing studs extend from the electronic board 22.

The electronic board 22 comprises a printed circuit extending substantially parallel to the support and on which a camera, an infrared receiver and a microphone are mounted. The camera is disposed facing a circular hole provided in the support 21, the hole being covered with a protective glass 23 substantially flush with the front face 10c of the casing 10.

It will be noted that the support 21 is, in this case, made of a material which is transparent or translucent to infrared light. This is, for example, a polycarbonate- or MABS-type (methyl acrylonitrile butadiene styrene methacrylate) plastic material.

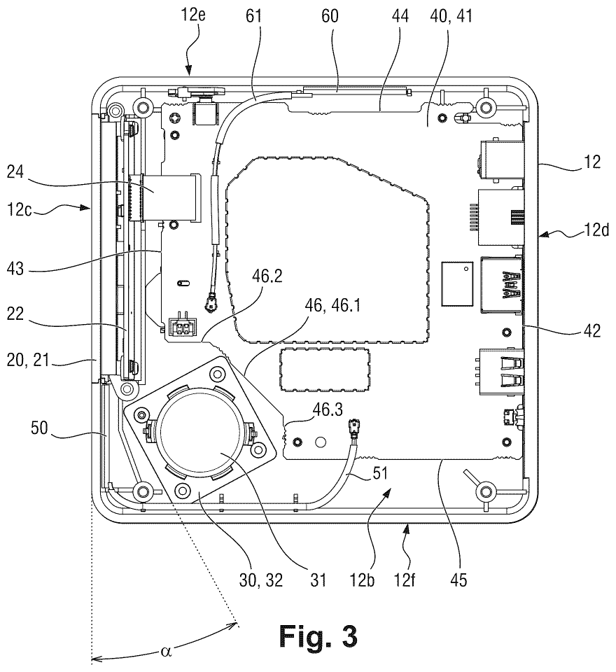

As illustrated in FIGS. 2 and 3, the speaker 30 is integrated in the casing 10 and comprises, in a manner known per se, a bowl 31 inside which a coil is movably mounted via a magnet, the coil being coaxially connected to a membrane 32, the movement of which induces acoustic pressure variations generating sounds. The bowl 31 has a central axis extending substantially vertically and comprises a square-shaped base 33 extending horizontally facing the bottom of the cap 12 in a plane P₃₃. The central axis of the bowl 31 is also that of the speaker 30. The base 33 is provided, at each corner, with a hole facing a screwing stud extending vertically projecting from the bottom of the cap 12, such that the speaker 30 is called upwards oriented and is fixed to the lower face of the upper panel 12b of the cap 12 via the base 33.

The speaker 30 is disposed in a corner of the cap 12 delimited by the front panel 12c and the left side panel 12f. It will be noted that none of the right sides of the base 33 of the speaker 30 extend, in this case, parallel to the front panel 12c or to the left side panel 12f: the side of the base 33 extending to the vicinity of the front panel 12c and of the left side panel 12f forms, seen from the horizontal plane P₃₃, an angle α which is non-zero and different by 90 degrees with the front panel 12c. The angle α is, in this case, substantially equal to 25 degrees. It is understood that all of the right edges of the base 33 form, with the edges of the upper panel 12b, an angle which is different by 0 degrees and 90 degrees, such that none of said right edges of the base 33 extend parallel to an edge of said upper panel 12b seen from the plane P₃₃. Such an angular orientation of the speaker 30 about its central axis makes it possible, in particular, to limit the dimensions by width and by length of the casing 10.

In order to enable the articulation of the membrane 32 of the speaker 30, a circular opening 12.2 is provided in the cap 12, coaxially to the membrane 32. It is said that the speaker 30 opens into the opening 12.2. It will be noted that the opening 12.2 has, in this case, a diameter greater than that of the membrane 32 and less than the large diameter of the bowl 31.

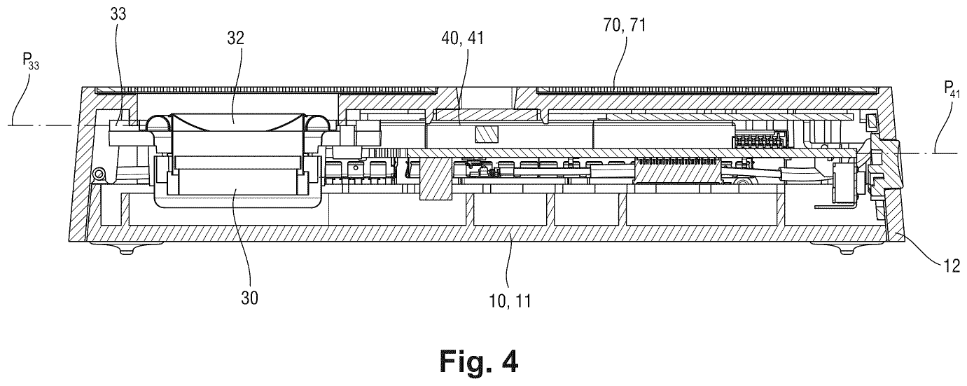

As illustrated in FIGS. 2 to 4, the motherboard 40 is integrated in the casing 10 and comprises a printed circuit 41 on which components such as a processor, a memory and connectors are mounted. The printed circuit 41 extends substantially horizontally into a plane P₄₁ between said chassis 11 and the upper panel 12b of the cap 12, and is screwed (and not clipped) to said upper panel 12b of the cap 12 via fixing studs extending vertically projecting from the bottom of the cap 12, so as to limit the relative movements between the motherboard 40 and the cap 12. The printed circuit 41 has, in this case, mainly the shape of a rectangle, a corner of which has been indented to partially receive the speaker 30. The printed circuit 41 comprises:
a rear edge 42 extending in the proximity and parallel to the rear panel 12d of the cap 12;
a front edge 43, opposite the rear edge 42, extending in the proximity and parallel to the support 21 of the electrical module 20;
a right side edge 44 extending in the proximity and parallel to the right side panel 12e of the cap 12, the right side edge 44 connecting the rear edge and the front edge;
a left side edge 45, opposite the right side edge 44, extending in the proximity and parallel to the left side panel 12f of the cap 12, the left side edge 45 being connected to the rear edge; and
an indented edge 46 connecting the front edge 43 and the left side edge 45 to be horizontally facing the bowl 31 of the speaker 30.

The indented edge 46 comprises a central portion 46.1, a first side portion 46.2 and a second side portion 46.3. The first side portion 46.2 extends substantially perpendicularly to the front edge 43 and connects said front edge 43 to the central portion 46.1. The second side portion 46.3 extends substantially perpendicularly to the left side edge 45 and connects said left side edge 45 to the central portion 46.1. The first side portion 46.2 and the second side portion 46.3 have a substantially identical length, the side portion extending mainly at 45 degrees.

It is understood that the speaker 30 is not placed above or below the motherboard 40, but next to said motherboard 40.

As illustrated in FIGS. 2 and 3, the first antenna 50 and the second antenna 60 are integrated in the casing 10.

The first antenna 50 extends parallel to the front panel 12c of the cap 12 and is flattened against it, facing the speaker 30. The first antenna 50 is connected to the printed circuit 41 of the motherboard 40 via a first connecting cable 51.

The second antenna 60 extends parallel to the right side panel 12e of the cap 12 and is flattened against it, in the proximity of the middle of the left side edge of the printed circuit 41 of the motherboard 40. The second antenna 60 is connected to the printed circuit 41 of the motherboard 40 via a second connecting cable 61.

The speaker 30 and the electronic board 22 of the electrical module 20 are themselves connected to the printed circuit 41 of the motherboard 40 via respectively a connecting layer 24 and connecting cables (not represented).

In order to optimise the overall volume of the casing 10, the chamber (E) delimited by the chassis 11 and the cap 12 is not acoustically insulated, such that the casing 10 does not form a closed chamber for the speaker 30. Subsequently, the chassis 11 comprises ridges comprising a first series of ridges 11.1 and a second series of ridges 11.2 arranged to limit the acoustic resonance inside the casing 10, while improving the rigidity of said chassis 11. The first series of ridges 11.1 and the second series of ridges 11.2 extend vertically projecting from the upper face of the chassis 11 and have, in this case, a height h substantially equal to 6.4 millimetres.

The first series of ridges 11.1 defines a honeycomb structure extending into the central part of the chassis 11. The honeycomb structure is mainly square-shaped and comprises hexagonally-shaped pits 11a making it possible to break stationary waves. The pits 11a are disposed either side of the reinforcing ridges 11.3 each extending substantially along a diagonal of the honeycomb structure. The reinforcing ridges 11.3 each extending from a cylindrical-shaped central ridge 11.4 located at the centre of the chassis 11, in the direction of one of the fixing studs 11.6 to receive the feet 13.

The second series of ridges 11.2 defines rectangular cavities 11b extending around the honeycomb structure, mainly at the periphery of the chassis.

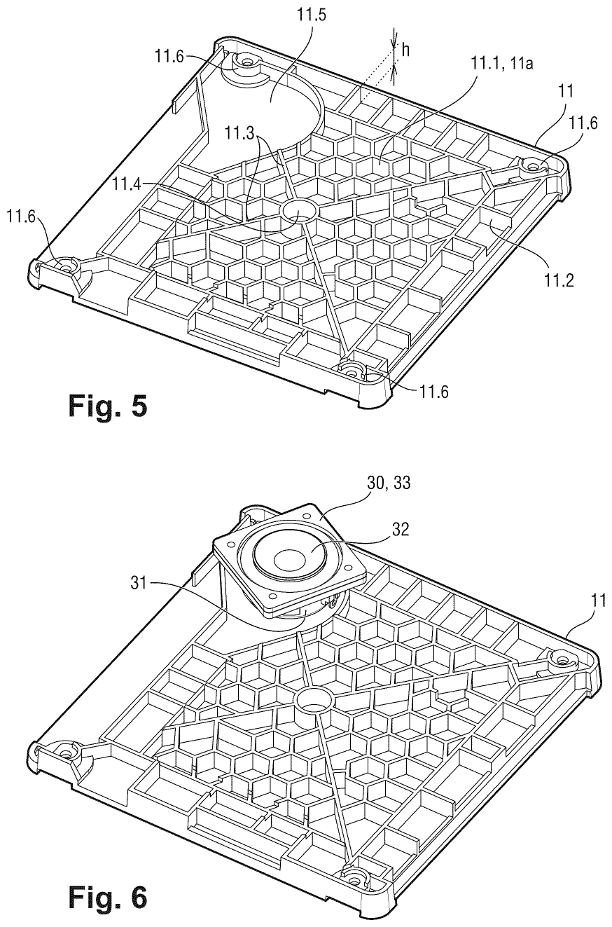

It will be noted that the first series of ridges 11.1 and the second series of ridges 11.2 delimit a zone 11.5 for receiving a rear part of the bowl 31 of the speaker 30 (FIGS. 5 and 6), such that none of the ridges extends below said bottom of the bowl 31 so as to optimise the height H of the casing 10.

The upper panel 12b of the cap 12 is coated with an insert 70 arranged to protect the speaker 30 from the elements which are external to the casing 10, and in a lesser measure, dust. The insert 70 comprises a plate 71 provided with a plurality of orifices equally distributed over the entire surface of the plate 71 to form a protective grille which is permeable to sound waves. The plate 71 comprises a lower face provided with an acoustic fabric (not represented) extending over the entire surface of the plate 71 to protect the speaker 30 from dust.

The insert 70 is, in this case, fixed onto the upper panel 12b of the cap 12 by a double-sided adhesive. An outflow of a height substantially equal to 1 millimetre is provided on the upper face 10b of the casing 10 to receive the insert 70.

The insert 70 also makes it possible to conceal cosmetic defects of the upper panel 12b linked to the method for injecting plastic of the cap 12, and in particular, piping generated during the stripping of technical functions such as fixing studs.

Naturally, the invention is not limited to the embodiment described, but comprises any variant entering into the field of the invention, such as defined by the claims.

The speaker 30 can moreover be arranged in a corner of the cap 12 (as soon as it remains upwards oriented). The speaker 30 can, for example, be arranged in the middle of the upper panel 12b of the cap 12.

The shape of the casing 10 can be different from that described and be, for example, cylindrical.

The first series of ridges 11.1 and the second series of ridges 11.2 can form patterns which are different from those described and/or have a different density.

The tilt angle α of the speaker 30 can be zero and different by 25 degrees.

The circular opening 12.2, wherein the speaker 30 opens can be replaced by a multitude of orifices.

Only the part of the insert 70 located above the speaker 30 must be permeable to sound waves. The equal distribution of the orifices of the plate 71 and the almost total coverage of the lower face of the plate 71 by the acoustic fabric mainly makes it possible to improve the visual uniformity of the set-top box 1.

1. Electrical equipment comprising a casing defining a chamber, wherein a motherboard and a speaker connected to the motherboard are disposed, a membrane of the speaker opening into at least one opening provided in an upper panel of the casing, and the motherboard extending into a first transverse plane of the speaker, this first plane being substantially parallel to the upper panel, the speaker comprises a square-shaped base extending into a second plane substantially parallel to the upper panel, none of the edges of the base extending parallel to an edge of the upper panel seen from the second plane.

2. The electrical equipment according to claim 1, wherein the upper panel is rectangular-shaped, the opening being provided in a corner of the upper panel.

3. The electrical equipment according to claim 1, wherein the motherboard comprises a printed circuit provided with an indentation arranged to receive the speaker, at least partially.

4. The electrical equipment according to claim 1, wherein the speaker is fixed to the upper panel.

5. The electrical equipment according to claim 1, wherein the casing comprises a chassis comprising ridges comprising a first series of ridges and a second series of ridges which extend vertically from a bottom of the chassis and which are respectively disposed in the central part of the bottom of the chassis and at the periphery of the central part, the first series of ridges being arranged according to a honeycomb structure comprising hexagonal-shaped pits.

6. The electrical equipment according to claim 5, wherein the honeycomb structure is mainly square-shaped, and the pits are disposed either side of reinforcing ridges each extending substantially along a diagonal of the honeycomb structure.

7. The electrical equipment according to claim 6, wherein the ridges comprise a cylindrical-shaped central ridge located at the centre of the chassis, the chassis comprising four fixing studs intended to each receive a foot of the electrical equipment, and the reinforcing ridges each extending from the central ridge in the direction of one of the fixing studs.

8. The electrical equipment according to claim 5, wherein the ridges delimit a zone for receiving a rear part of the speaker.

9. The electrical equipment according to claim 5, wherein the casing comprises a cap surmounting the chassis, the cap comprising the upper panel and a skirt connecting the upper panel to said chassis.

10. The electrical equipment according to claim 1, the electrical equipment being a set-top box.
